(19) United States
(12) Patent Application Publication
(10) Pub. No.: US 2022/0325138 A1
(43) Pub. Date: Oct. 13, 2022

(54) WATER REDUCIBLE WAX COATING

(71) Applicant: Z Technologies Corporation, Redford, MI (US)

(72) Inventor: Ellis Breskman, Redford, MI (US)

(21) Appl. No.: 17/711,499

(22) Filed: Apr. 1, 2022

Related U.S. Application Data
(60) Provisional application No. 63/174,138, filed on Apr. 13, 2021.

(51) Int. Cl. C09D 191/06; C09D 5/08; C09D 133/08; C09D 7/61; C09D 7/63; C09D 7/80

(52) U.S. Cl. CPC C09D 191/06; C09D 5/08; C09D 133/08; C09D 7/61; C09D 7/63; C09D 7/80

(57) ABSTRACT

A relatively low cost, water-based coating, intended to protect metal from corrosion, exhibiting excellent corrosion resistance, is formed by emulsification of oxidized soap wax containing a small amount of petroleum distillate, and other liquid additives. The resulting emulsion is modified to produce firm dry films, by addition of pigment followed by addition of highly polar acrylic resins. The pigmented composition is further modified with gelled metal sulphonates, to attain significant anti-corrosion properties.

### BACKGROUND OF THE INVENTION

The present invention relates generally to a water-based, wax-based, coating intended for application to chassis components, and other transportation equipment for purposes of corrosion prevention. The prior art in the field of corrosion prevention coatings encompasses water and solvent based coatings, and hot melted coatings. Many of these coatings are applied to the underside of vehicles or to chassis parts that will be assembled to create a vehicle.

Some coatings may be applied via spray, and these coatings are generally solvent-based or water-based. In order to obtain optimum corrosion protection while using a water-based coating, a significant cleaning pre-treatment is required. In the automotive industry, this cleaning procedure consists of multiple shower booths in which the metal components are washed in several stages. It is common to have seven stages, which generally consist of 1) hot alkaline water; 2) clean water rinse; 3) hot acid wash activation; 4) hot acid wash; 5) hot seal coat; 6) clean water rinse; and 7) DI halo. After wash pretreatment, the parts must be dried off in an oven. Except for stage 7, the water in each bath is not disposed of but is recirculated for a set number of factory shifts, or upon a threshold titration, and then sent out for waste treatment.

In addition, most water-based chassis coatings that provide corrosion protection are made from synthetic polymeric film formers. These synthetic polymeric film formers require multiple reactions and chemical processes, in addition to expensive ingredients that provide the corrosion protection. Water-based chassis coatings, in the current art, generally achieve a corrosion prevention score of 500. Corrosion scores are the industry indicator for performance properties from accelerated durability testing, which is performed on coating, spray-applied to substrate, after the wash pretreatment described above.

The water-based coatings have several advantages over solvent-based coatings. First, water-based coatings are more likely to comply with United States Environmental Protection Agency (“EPA”) regulations. Water-based paint waste is usually not considered hazardous waste. Additionally, solvent-based coatings are more flammable, heightening insurance concerns. Because of this flammability, special and expensive electrical codes must be adhered to in locations where solvent-based coatings are applied.

In the previous art, oxidized soap wax (also referred to as “OSW”) coatings have only been solvent-based. These coatings also have certain advantages. No pretreatment wash is required when an oxidized soap wax coating is to be applied. These coatings also achieve a higher corrosion score of approximately 1000. Solvent-based coatings are made from a fraction of crude oil that is not highly sought-after, resulting in a significant cost advantage. These coatings also present no need for the expensive anti-corrosion ingredients required for water-based coatings. Finally, components utilizing solvent-based coatings are easily repaired with a quick touch-up.

In the prior art, oxidized soap wax coatings modified with gelled calcium sulphonates can exhibit an accelerated corrosion score of 5000, especially in areas where the test films were intentionally damaged before exposure. For example, Society of Automotive Engineers Standard 2721 sets forth the procedure for testing corrosion after damage has occurred, such as from stone or gravel impingement.

US Patent 2002/0058749 A1, by Dow, teaches how to produce acrylic emulsions with high acid and other polar groups that will be attracted to and encapsulate pigments found in a coating. The encapsulated pigments allow no voids in the coating that might result in migration of corrosive chemicals to the metal surface. Technical data sheets for Dow's AVANCE 200 Emulsion illustrate electron microscopic photos of the AVANCE encapsulating the pigment particles.

U.S. Pat. No. 5,455,075, by Daubert Chemical Company, Inc., discloses a wax-based coating that is applied after heating to 280° F. The coating is composed of melted wax and “dries” when the component to which the wax was applied is allowed to cool. The disadvantage of this coating is the difficulty of keeping large quantities of the coating at 300° F. and the metal preheating temperatures required. However, this coating produces no Volatile Organic Compound (“VOC”) emissions and results in uniform coverage on the inside box sections of chassis.

In the prior art, oxidized wax (also referred to as “OW”) emulsions are commonly used as underbody coatings. The oxidized wax is available from companies such as the Lubrizol Corporation, Lockhart Chemical Company, and others under the Chemical Abstract Service Registry Number 64743-01-7. These emulsions are prepared by first melting the oxidized wax at approximately 140° F., and adding water, emulsifier, and a co-solvent to form a stable emulsion. Coatings based on oxidized wax emulsions are relatively inexpensive. Usually such coatings have some VOC, due to use of non-exempt organic co-solvent. They exhibit a corrosion protection score of 50. The oxidized soap wax, dispersed in organic solvent, exhibits a corrosion protection score of 1000. Oxidized soap wax has not, until this invention, been offered as emulsions, because when the oxidized wax is changed to an oxidized soap wax, the melting point increases substantially, from approximately 140° F. to approximately 340° F. This heat is difficult and dangerous for forming the oxidized wax emulsion. Also, while emulsions of oxidized soap wax in water initially exhibit excellent corrosion protection, such emulsions exhibit sudden catastrophic failure during accelerated exposure.

The oxidized soap wax emulsions which are the subject of the instant invention, which have been formed without liquification, are solid oxidized soap wax particles emulsified in water, instead of liquidized oxidized soap wax particles. The liquidized oxidized soap wax particles are liquid when applied, dispersed as an emulsion. These particles can flow and coalesce to form a continuous film. This produces excellent corrosion protection. This invention utilizes liquified oxidized soap wax to form films exhibiting excellent corrosion protection.

Most manufacturers of truck bodies, van bodies, and utility trailers currently utilize asphalt-based, water-based underbody coatings, without metal pretreatment. This process yields a corrosion protection score of 5 to 50.

The instant invention is a water based, wax based anti-corrosion coating offering significantly lower cost with increased protection, and which does not require metal pretreatment. It exhibits an accelerated corrosion score of 1000 to 5000.

Coatings prepared by the process taught in this invention, applied to pretreated substrate (such as described in the wash procedure set forth above), achieve a corrosion protection score of 5000.

Although this coating was developed with the intent to protect chassis components, it is a potent anti-corrosion coating and other uses, such as bridges, marine corrosive environments, and steel structural components and other uses are envisioned.

### SUMMARY OF THE INVENTION

This invention relates to a method of forming a water-based, wax based coating which is extremely low in volatile organic compounds and which can be applied to metal substrate, with or without metal pretreatment, for the purpose of corrosion protection.

### BRIEF DESCRIPTION OF THE DRAWINGS

FIG. 1 illustrates a flow chart detailing the method of forming a water-based emulsion of the present invention. In the pigment step, the order of addition is important: The copolymer is added slowly after the addition of pigment.

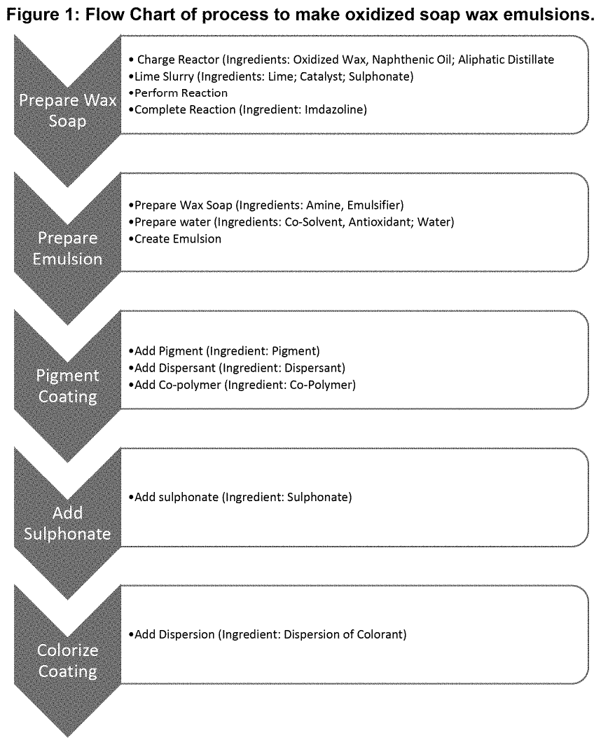

### DETAILED DESCRIPTION OF THE PREFERRED EMBODIMENT

The various features and advantages of the invention will become apparent to those skilled in the art from the following detailed description of the currently preferred embodiment.

The first step in instant invention is to charge a process vessel with oxidized petrolatum (Chemical Abstract Service Registry Number 64743-01-7). This product is available from Lockhart Chemical under the tradename Counterrust 6000. The oxidized petrolatum, which melts at approximately 140° F., is raised to a temperature of approximately 250° F.

A lime slurry is prepared, consisting of 142 flash mineral spirits (Chemical Abstract Service Registry Number 64742-47-8); Mississippi Lime (Chemical Abstract Service Registry Number 01305-62-0); a catalyst such as Surfactant Calcium Acetate (Chemical Abstract Service Registry Number 62-54-4); a sodium sulphonate (Chemical Abstract Service Registry Number 68608-26-4, sold by Lockhart Chemical under the trade name EZ Mulz 2000); and 100 weight naphthenic oil (Chemical Abstract Service Registry Number 64742-52-5).

The lime slurry is then added to the heated oxidized petrolatum. The concentration of lime is stoichiometrically equivalent to the concentration of acid present in the oxidized wax. The mixture is held at 250° F., normal atmosphere, for two hours.

After two hours, Imidazoline T (Chemical Abstract Service Registry Number 61791-39-7) is added and the mixture is allowed to cool. The resulting mixture, the wax oxidate soap, is equivalent to Chemical Abstract Service Registry Number 68425-34-3, which is an oxidized petrolatum soap available from the Lubrizol Corporation as Alox 606, cut back with aliphatic petroleum distillates. Another substantial equivalent can be procured from Lockhart Chemical Co., sold under the brand Counterrust 6600. However, there is a significant difference between the mixture taught through the instant invention, which contains 6 to 8% mineral spirits, as Alox 606 and Counterrust 6600 each contain 45% mineral spirits.

It is important that the oxidized soap wax contain a small amount of aliphatic petroleum distillates because the oxidized soap wax has a very high melting point (greater than 300° F.). The emulsion particles are unable to coalesce at room temperature when the emulsion coating is applied to a substrate. The inability to coalesce results in improper film formation and accelerated corrosion failure. Only a small amount of aliphatic petroleum distillate (“AP”) is required. For best results, 140 flash aliphatic petroleum distillate is preferred because it evaporates last from the drying film. While a range of amounts of aliphatic petroleum distillate will work, for the optimum performance, an amount of 6%, based on formula weight of wax, is best.

The 6% of aliphatic petroleum distillate in the final formula results in a negligible amount of VOC. In addition to the aliphatic petroleum distillate, in order to liquify the wax to form final film properties, an oil is also added to the wax before emulsification. We find that the best oil is 100 weight naphthenic oil, widely available from various chemical suppliers, although paraffinic oil also works. Additionally, an emulsifier is added to the wax before the wax is converted to a soap. We find the best emulsifier is sulphonate, such as sodium sulphonate available from Lockhart Chemical mentioned earlier.

The resulting mixture is liquid at room temperature. This is very important for room temperature film formation. The minimum film formation temperature can be increased by removal of the aliphatic petroleum distillate.

The mixture is now ready for emulsification in water. Emulsifier is added to the oxidized soap wax containing aliphatic petroleum distillate. Multiple emulsifiers allow for the transition of the oxidized soap wax to an emulsion; however, the best combination is AMP-95 (from Angus Chemical), in combination with PEG phosphate (Chemical Abstract Service Registry Number 39464-69-2, available from Colonial Chemical). AMP-95 is the only amine available which is not listed by the US Environmental Protection Agency, as a VOC (Volatile Organic Compound).

The amine and PEG phosphate are mixed with the oxidized soap wax mixture. Under agitation, ambient temperature water mixed with an organic cosolvent and anti-oxidant (to inhibit flash rust), is then slowly added to the wax mixture at room temperature. This mixture will become a brown emulsion. Many cosolvents are effective, but di methyl carbonate at 1.08% formula weight, is preferred, because it has a fast evaporation rate. This, which hastens film formation, is also preferred because it is not listed as a VOC by the US EPA. Many anti-oxidants are available, however, sodium nitrite, at 0.28% formula weight, performs best for this coating.

The emulsion formed exhibits excellent accelerated corrosion resistance but the film consistency is very soft. The dry film is easily deformed by abrasion. The emulsion formed at this stage of the procedure is an excellent corrosion protectant where abrasion of the film is not an issue.

The film can be made more abrasion resistant by addition of fumed silica. However, the addition of pigment is preferred over silica, which serves to impart film properties with more modulus of restoring force.

Adding pigment to the emulsion is required to render a tough film that can be utilized for corrosion protection. Adding pigment by most methods results in catastrophic film failure in accelerated corrosion testing. However, using a commercial water-based emulsion with a very high acid number to first encapsulate the pigment avoids this failure. The resin AVANCE 200, at 12.7% formula weight, from Dow Chemical Company, performs best. The technical information provided by DOW with regard to AVANCE 200 indicates that the resin encapsulates the pigment particles, and only is effective in encapsulating certain pigments, including titanium dioxide and calcium carbonate.

The best pigment is a calcium carbonate with a relatively large particle size. A good example of such a pigment is Omya Curb 6, at 54.2% formula weight, available from Omya.

Before adding the pigment to the emulsion, a dispersant is added to the emulsion to facilitate initial pigment wetting. Numerous dispersants work; however, Tamol 165A, at 0.5% formula weight, from Dow Chemical Company, works best.

The pigment is mixed into the emulsion. The concentration of pigment is added to produce a dry film with Pigment Volume Concentration of 38%. Hegman grind is used to determine that pigment dispersion is complete.

The AVANCE is added slowly to allow the encapsulation of the pigment. The final film is a dry firm film that exhibits an accelerated corrosion score of 500.

Accelerated corrosion testing of the composition at this stage of the procedure set forth herein exhibits some corrosion if the film is cut or damaged before exposure to accelerated corrosion. To mitigate this, gelled calcium sulphonate (Chemical Abstract Service Number 68783-96-0) is mixed into the composition, at 15% by weight of the oxidized wax. The resulting composition exhibits a corrosion protection score of 1000. This indicates that almost no corrosion occurs in accelerated corrosion testing, even at areas where the film has been removed.

Additional colorant dispersions can be added, where the effect upon accelerated corrosion protection must be determined.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason, the following claims should be studied to determine the true scope and content of this invention.

What is claimed is:

1. A method for producing oxidized soap wax emulsion.

2. A method for producing a relatively inexpensive rust preventative that air-dries to form a firm film, and can protect metal substrate with or without pretreatment, and which is liquid at room temperature.

3. A method to prepare rust preventing coating that can be applied to transportation equipment or other substrate for corrosion protection.

4. A method for producing oxidized soap wax emulsion comprising the steps of:
a. Adding a small concentration of aliphatic distillate, naphthenic or paraffinic oils, metal sulphonates to the emulsion particles to facilitate coalescence, before emulsification;
b. Using amine and polyethylene phosphate to emulsify the oxidized soap wax;
c. Using VOC-exempt co-solvent such as dimethyl carbonate as a co-solvent with water;
d. Modifying the water with a flash rust inhibitor;
e. Adding water and cosolvent to produce a stable emulsion;
f. Use of a wetting agent to facilitate dispersion of pigment;
g. Adding pigment or fumed silica to increase toughness of film;
h. Adding highly polar and or acid-group-rich water based acrylic resin to encapsulate the added pigment;
i. Adding gelled metal sulphonate to further increase the corrosion resistance of the coating; and
j. Adding dispersion to provide color to the final coating.

5. An oxidized soap wax emulsion produced by the performing the steps of:
a. Adding a small concentration of aliphatic distillate, naphthenic or paraffinic oils, metal sulphonates to the emulsion particles to facilitate coalescence, before emulsification;
b. Using amine and polyethylene phosphate to emulsify the oxidized soap wax;
c. Using VOC-exempt co-solvent such as dimethyl carbonate as a co-solvent with water;
d. Modifying the water with a flash rust inhibitor;
e. Adding water and cosolvent to produce a stable emulsion;
f. Use of a wetting agent to facilitate dispersion of pigment;
g. Adding pigment or fumed silica to increase toughness of film;
h. Adding highly polar and or acid-group-rich water based acrylic resin to encapsulate the added pigment;
i. Adding gelled metal sulphonate to further increase the corrosion resistance of the coating; and
j. Adding dispersion to provide color to the final coating.
